(19) United States
(12) Patent Application Publication
(10) Pub. No.: US 2019/0095645 A1
(43) Pub. Date: Mar. 28, 2019

(54) The process of adding an endorsement to an existing Professional Liability/Errors & Omissions Insurance Policy to offer Cyber Liability/Cyber Data Breach Insurance to a policyholder's client

(71) Applicant: Justin Reinmuth, Worthington, OH (US)

(72) Inventor: Justin Reinmuth, Worthington, OH (US)

(21) Appl. No.: 15/713,086

(22) Filed: Sep. 22, 2017

(51) Int. Cl. G06F 21/62

(52) U.S. Cl. CPC G06F 21/6272; G06F 21/6227; G06F 21/6245

(57) ABSTRACT

The current invention is the process of adding an endorsement to an existing Professional Liability/Errors & Omissions Insurance Policy to offer Cyber Liability/Cyber Data Breach Insurance to a policyholder's client. The process involves an endorsement that goes into effect when a technology client (or their client) sends in a completed minimum security standards warranty letter.

The process of adding an endorsement to an existing Professional Liability/Errors & Omissions Insurance Policy to offer Cyber Liability/Cyber Data Breach Insurance to a policyholder's client

### CROSS-REFERENCES TO RELATED APPLICATIONS (IF ANY)

None

### BACKGROUND

### 1. Field of the Invention

The present invention relates to a process of adding an endorsement to an existing Professional Liability/Errors & Omissions Insurance Policy to offer Cyber Liability/Cyber Data Breach Insurance to a policyholder's client.

### 2. Description of Prior Art

The costs associated with the disclosure of Personally Identifiable and/or Protected Health Information can be significant to an organization. Costs incurred include but are not limited to Notification, Forensics, Public Relations and Regulatory Defense.

There is still room for an affordable solution to an organization that stores, maintains and processes Personally Identifiable and/or Protected Health Information.

### SUMMARY OF THE INVENTION

The current invention is the process of adding an endorsement to an existing Professional Liability/Errors & Omissions Insurance Policy to offer Cyber Liability/Cyber Data Breach Insurance to a policyholder's client.

The process involves an endorsement that goes into effect when the technology client sends in a warranty letter that they, and their client signs, stating that this client has the minimum security standards in place.

By making the technology company's client comply with certain security measures and the fact that the technology company has gone through an application process as well as a 3^{rd} party network security risk assessment to secure a policy, this process allows the carrier to have a greater level of comfort that the proper security measures are in place for the client receiving the endorsement.

This process is more efficient, effective and accurate since the carrier is familiar with the interworking's of the technology company and their client as it relates to industry best practices.

### BRIEF DESCRIPTION OF THE DRAWINGS

Without restricting the full scope of this invention, the preferred form of this invention is illustrated in the following drawings:

FIG. 1 shows a screen of the coverage questions.

### DESCRIPTION OF THE PREFERRED EMBODIMENT

There are a number of significant design features and improvements incorporated within the invention.

The current invention is a system and process of adding an endorsement to an existing Professional Liability/Errors & Omissions Insurance Policy to offer Cyber Liability/Cyber Data Breach Insurance to a policyholder's client.

The process involves an endorsement that goes into effect when the technology client sends in a warranty letter that they, and their client, sign stating that this client has the minimum security standards in place.

The system is designed to make sure that the technology company's client has the proper security in place prior to receiving the insurance coverage. This security lessens the chances of a claim being made against the policy.

The process has the following steps:

The company sends a technology prospect their Application and Risk Assessment to be completed. Upon its receipt, the Application is reviewed by an in-house underwriter and the Risk Assessment is sent to a third party to be reviewed. This can all be done through electronic transmissions.

If they qualify, an indication letter is generated by the underwriter and sent to the technology prospect with a copy of the policy form. If the technology prospect wants to move forward, they must receive a passing grade from the third party reviewer as it relates to the Risk Assessment based on their risk questionnaire. If the client receives a recommendation grade from the third party reviewers, they must comply with these recommendation(s) within 60 days to keep coverage in place.

Once the policy is issued, the technology client can endorse their client onto the policy (attached) to protect that organization from Cyber Liability/Cyber Data Breach claims.

Examples of claims covered by the process include but are not limited to: Theft of Hardware, Lost/Stolen Laptop or Device, A Staff Mistake, A Rogue Employee, Paper Records, Theft of Money.

In order for a technology clients' client to move forward and be added onto the policy, both parties must complete and send in a Cyber Data Breach Minimum Security

Standards letter to be reviewed. If approved, the endorsement is generated and their client is added onto the policy via an endorsement.

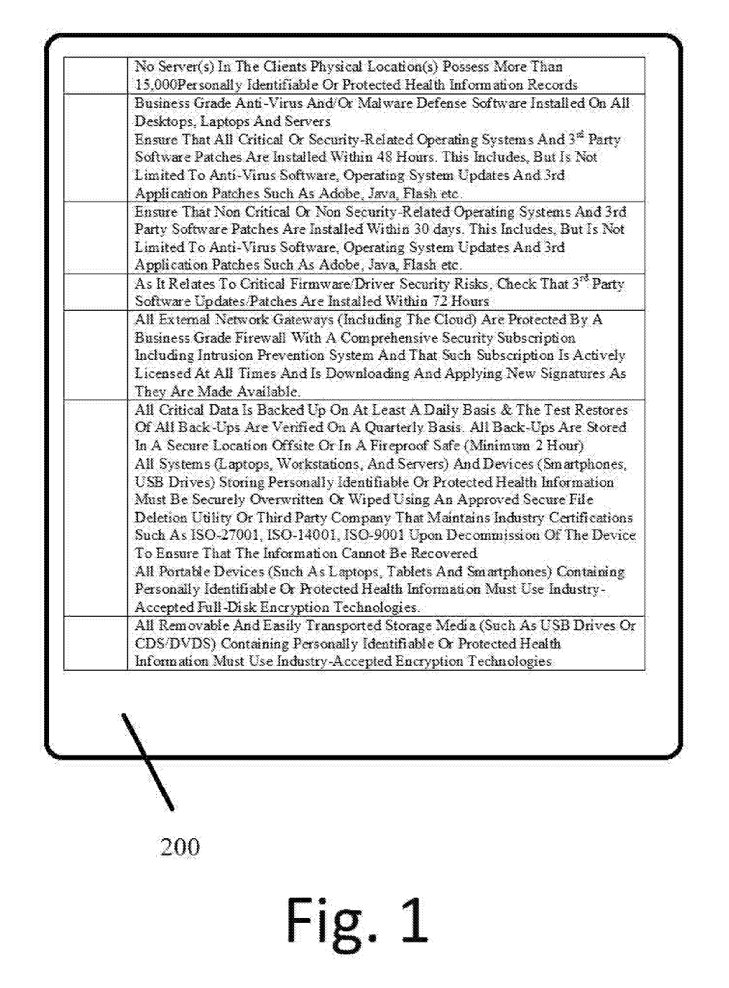

As shown in FIG. 1, an example of some of the questions which can be answered on a computing device and screen for the electronic process.

No Server(s) In The Clients Physical Location(s) Possess More Than 30,000 Unique Personally Identifiable Or Protected Health Information Records. The Server(s) Must Be NIST Full Disk Encrypted Or File/Folder Encrypted And Be Monitored Daily. Business Grade Anti-Virus And/or Malware Defense Software Installed On All Desktops, Laptops And Servers. Ensure That All Critical Or Security Related Operating Systems And 3^{rd} Party Software Patches Are Installed On Desktops Within 2 to 7 Days And Are Installed On Servers Within 30 Days Of Their Release. This Includes, But Is Not Limited To Anti-Virus Software, Operating System Updates And 3^{rd} Party Application Patches Such As Adobe, Java, Flash etc. Ensure That Non-Critical Or Non-Security Related Operating Systems And 3rd Party Software Patches Are Installed Within 30 Days Of Their Release. This Includes, But Is Not Limited To Anti-Virus Software, Operating System Updates And 3^{rd} Party Application Patches Such As Adobe, Java, Flash etc. As It Relates To Critical Firmware/Driver Security Risks, Check That 3^{rd} Party Software Updates/Patches Are Installed Within 2 to 7 Days After The IT Client Is Made Aware Of It From The Manufacturer. All External Network Gateways (Including The Cloud) Are Protected By A Business Grade Firewall With A Comprehensive Security Subscription Including Intrusion Prevention System And That Such Subscription Is Actively Licensed At All Times And Is Downloading And Applying New Signatures As They Are Made Available. All Critical Data Is Backed Up On At Least A Daily Basis and The Test Restores Of All Back-Ups Are Verified On A Quarterly Basis. All Back-Ups Are Stored In A Secure Location Offsite Or In A Fireproof Safe (Minimum 2 Hour). All Systems (Laptops, Workstations, And Servers) And Devices (Smartphones, USB Drives) Storing Personally Identifiable Or Protected Health Information Must Be Securely Overwritten Or Wiped Using An Approved Secure File Deletion Utility Or Third Party Company That Maintains Industry Certifications Such As ISO-27001, ISO-14001, ISO-9001 Upon Decommission Of The Device To Ensure That The Information Cannot Be Recovered. All Portable Devices (Such As Laptops, Tablets And Smartphones) Containing Personally Identifiable Or Protected Health Information Must Use Industry-Accepted Full-Disk Encryption Technologies. All Removable And Easily Transported Storage Media (Such As USB Drives Or CDS/DVDS) Containing Personally Identifiable Or Protected Health Information Must Use Industry-Accepted Encryption Technologies.

In summary, the endorsement is added to the policy form once the technology client (or their client) sends in the completed minimum security standards letter.

### Conclusion

Since the technology company has completed an application and passed the 3^{rd} party review of their risk assessment, this process allows the carrier to have a greater level of comfort that the proper security is in place for the client receiving the endorsement.

The carrier is more familiar with the interworking's of the technology client as a current policyholder greatly improving the process over prior art.

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system to offer Cyber Liability/Cyber Data Breach coverage comprising; having a technology clients' client wanting coverage; having the technology clients' client complete a minimum security standards letter.
